(19) United States
(12) Patent Application Publication
(10) Pub. No.: US 2017/0108750 A1
(43) Pub. Date: Apr. 20, 2017

(54) LIQUID CRYSTAL DISPLAY DEVICE

(71) Applicant: Japan Display Inc., Tokyo (JP)

(72) Inventors: Koichi IGETA, Tokyo (JP); Masateru MORIMOTO, Tokyo (JP)

(21) Appl. No.: 15/274,677

(22) Filed: Sep. 23, 2016

(30) Foreign Application Priority Data
Oct. 15, 2015 (JP) 2015-203585

(51) Int. Cl. G02F 1/1362; G02F 1/1339; G02F 1/1343; G02F 1/1368; G02F 1/1333

(52) U.S. Cl. CPC G02F 1/136286; G02F 1/1368; G02F 1/133345; G02F 1/134336; G02F 1/13394; G02F 2201/123; G02F 2201/121; G02F 2202/103; G02F 2202/104

(57) ABSTRACT

A liquid crystal display device includes a thin-film transistor (TFT) substrate and a counter substrate disposed opposite to the TFT substrate. The TFT substrate has a scanning line, a video signal line, and a TFT formed thereon, the TFT being connected to the scanning line and video signal line. The TFT substrate and the counter substrate sandwich liquid crystal therebetween. The TFT substrate has a first electrode connected to the TFT, an insulating film, and a second electrode disposed opposite to the first electrode with the insulating film interposed therebetween. The TFT substrate further has a third electrode formed in the same layer as that of the scanning line. The second electrode has an opening formed between the third electrode and the liquid crystal. The opening has a diameter parallel to a direction in which the scanning line extends and a diameter perpendicular to the scanning line extending direction.

### CLAIM OF PRIORITY

The present application claims priority from Japanese Patent Application JP 2015-203585 filed on Oct. 15, 2015, the content of which is hereby incorporated by reference into this application.

### BACKGROUND OF THE INVENTION

1. Field of the Invention

The present disclosure relates to a display device. More particularly, the disclosure relates to a liquid crystal display device that provides against display unevenness attributable to ion aggregates.

2. Description of the Related Art

Liquid crystal display devices are generally configured to have a thin-film transistor (TFT) substrate disposed opposite to a counter substrate with liquid crystal sandwiched therebetween, the TFT substrate typically having pixel electrodes and TFTs formed thereon in a matrix pattern. The display device forms an image by suitably controlling the light transmittance of liquid crystal molecules per pixel.

Liquid crystal includes ions that can trigger display unevenness when aggregating at particular locations under the influence of electric fields. JP-A-1991-167529 describes a configuration in which stacked films are partially removed from gate bus lines to form portions covered only by an alignment film, so that the portions trap ions and prevent them from aggregating in the screen periphery.

### SUMMARY OF THE INVENTION

What matters with the liquid crystal display device are its viewing angle characteristics. The in-plane-switching (IPS) method involves twisting liquid crystal molecules in parallel with the principal surface of the TFT substrate, thereby offering good viewing angle characteristics. With the IPS method, common electrodes and pixel electrodes are formed stacked with an insulating film interposed therebetween. That is, the IPS method is characterized by the common electrodes being also formed over the TFT substrate.

In such an electrode structure based on the IPS method, there occurs display unevenness caused by the phenomenon of ions in liquid crystal aggregating in a particular corner of the display, as shown in FIG. 3. Arrows 2 in FIG. 3 indicate how ions move. FIG. 3 schematically shows ions aggregating in the top right corner of a display area 1000 to trigger display unevenness 3 in that location.

The present disclosure has been made in view of the above circumstances and provides arrangements for countering display unevenness in the screen corner as shown in FIG. 3.

The present disclosure proposes overcoming the above circumstances using the typical embodiments to be described below. According to one embodiment of the present disclosure, there is provided a liquid crystal display device including a TFT substrate and a counter substrate sandwiching liquid crystal therebetween. The TFT substrate has scanning lines extending in a first direction and arrayed in a second direction perpendicular to the first direction, and video signal lines extending in the second direction and arrayed in the first direction. The scanning lines and the video signal lines intersect each other to form pixels therebetween. An insulating film formed over a first electrode is topped by a second electrode. A voltage impressed between the first and the second electrodes drives the liquid crystal. Either of the first and the second electrodes is a common electrode, the other electrode being a pixel electrode. A TFT switches a signal voltage to the pixel electrode. An ion trap electrode is formed in the same layer as that of a gate electrode in the TFT. The ion trap electrode is matched with an opening formed of the common electrode. The common electrode opening has a diameter parallel to the scanning lines and a diameter perpendicular thereto.

### BRIEF DESCRIPTION OF THE DRAWINGS

FIG. 1 is a schematic plan view showing how the present disclosure functions;

FIG. 2A is a cross-sectional view of a liquid crystal display device;

FIG. 2B is a plan view showing how pixels are arranged;

FIG. 3 is a schematic plan view showing display unevenness attributable to ion aggregates;

FIG. 4 is a cross-sectional view of a first embodiment of the present disclosure;

FIG. 5 is a graphic representation of drive voltages for a liquid crystal display device;

FIG. 6 is a cross-sectional view of a variation of the first embodiment;

FIG. 7 is a cross-sectional view of another variation of the first embodiment;

FIG. 8 is a plan view of the first embodiment;

FIG. 9 is a plan view of still another variation of the first embodiment;

FIG. 10 is a plan view of still another variation of the first embodiment;

FIG. 11 is a cross-sectional view of a second embodiment of the present disclosure;

FIG. 12 is a plan view of the second embodiment;

FIG. 13 is a plan view of a variation of the second embodiment;

FIG. 14 is a cross-sectional view of a third embodiment of the present disclosure;

FIG. 15 is a graphic representation of other drive voltages for the liquid crystal display device;

FIG. 16 is a plan view of the third embodiment;

FIG. 17 is a plan view of a variation of the third embodiment;

FIG. 18 is a plan view of another variation of the third embodiment;

FIG. 19 is a plan view of still another variation of the third embodiment;

FIG. 20 is a plan view of still another variation of the third embodiment;

FIG. 21 is a plan view of still another variation of the third embodiment;

FIG. 22 is a cross-sectional view of a fourth embodiment of the present disclosure;

FIG. 23 is a plan view of the fourth embodiment;

FIG. 24 is a plan view of a variation of the fourth embodiment;

FIG. 25 is a plan view of another variation of the fourth embodiment;

FIG. 26 is a plan view of still another variation of the fourth embodiment;

FIG. 27 is a plan view of still another variation of the fourth embodiment;

FIG. 28 is a plan view of still another variation of the fourth embodiment;

FIG. 29 is a plan view of a fifth embodiment of the present disclosure on the side of the TFT substrate;

FIG. 30 is a plan view of the fifth embodiment on the side of the counter substrate;

FIG. 31 is another plan view of the fifth embodiment on the side of the TFT substrate;

FIG. 32 is another plan view of the fifth embodiment on the side of the counter substrate;

FIG. 33 is a plan view showing a typical pixel in a sixth embodiment of the present disclosure;

FIG. 34 is a plan view of the sixth embodiment on the side of the TFT substrate;

FIG. 35 is a plan view of the sixth embodiment on the side of the counter substrate;

FIG. 36 is a plan view of a seventh embodiment of the present disclosure on the side of the TFT substrate; and

FIG. 37 is a plan view of the seventh embodiment on the side of the counter substrate.

### DESCRIPTION OF THE PREFERRED EMBODIMENTS

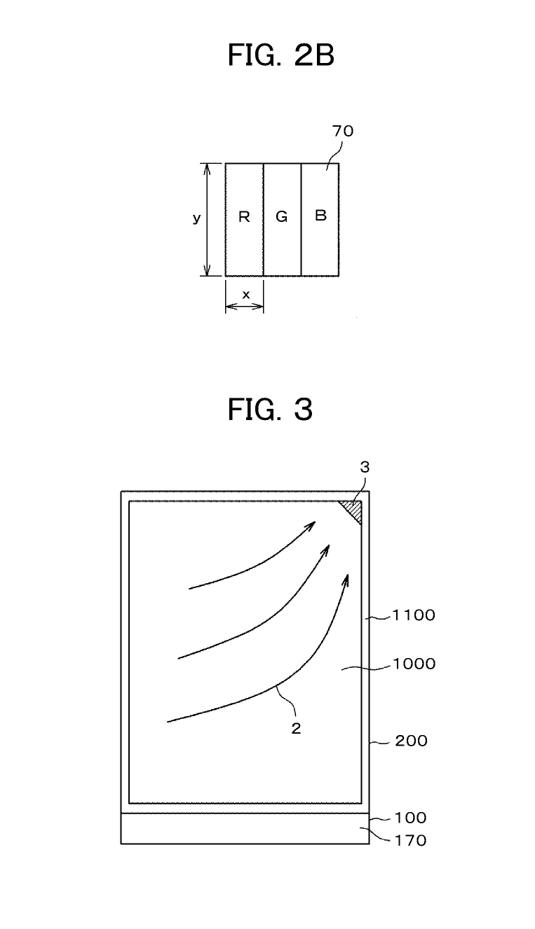

FIG. 2A is a schematic cross-sectional view of a liquid crystal display device. In FIG. 2, a counter substrate 200 is disposed opposite to a TFT substrate 100 with liquid crystal 300 sandwiched therebetween, the TFT substrate 100 having pixels that are arrayed in a matrix pattern and constituted by TFTs and pixel electrodes. The liquid crystal 300 is sealed between the substrates using a seal material 160 in their periphery. The gap between the TFT substrate 100 and the counter substrate 200 is determined by columnar spacers 60 formed on the side of the counter substrate 200. The TFT substrate 100 is formed to be larger than the counter substrate 200. That portion of the TFT substrate 100 which is not covered by the counter substrate 200 constitutes a terminal area 170. The terminal area 170 is designed to connect with an integrated circuit (IC) driver and a flexible wiring substrate.

FIG. 2B is a plan view showing how pixels 70 are arrayed over the TFT substrate. A red pixel R corresponding to a red color filter, a green pixel G corresponding to a green color filter, and a blue pixel B corresponding to a blue color filter make up one pixel set. These pixel sets are arrayed all over the display area. Screen resolution has improved significantly in recent years, so that the dimensions represented by x and y shown in FIG. 2B are extremely small. For example, the dimensions may be x=30 μm and y=90 μm or thereabouts in a liquid crystal display device having TFTs that use amorphous silicon (a-Si), to be discussed later in conjunction with embodiments. In a liquid crystal display device having TFTs that use poly-silicon, the dimensions may be x=20 μm and y=60 μm. In some products, the dimensions are even smaller: x=15 μm and y=45 μm or thereabouts.

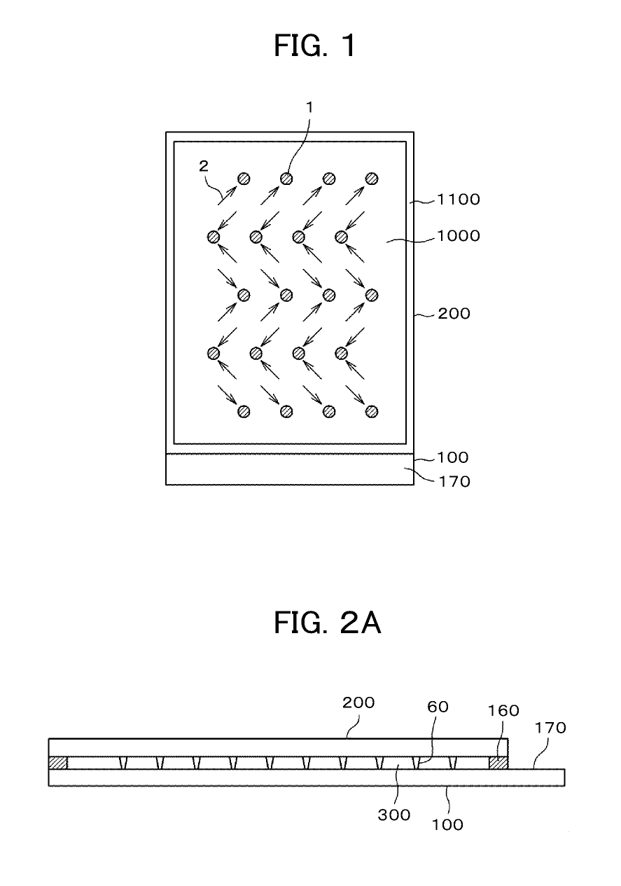

FIG. 1 is a schematic plan view showing how the present disclosure functions. In FIG. 1, liquid crystal is sandwiched between the TFT substrate 100 and the counter substrate 200. The periphery of the display area 1000 constitutes a frame area 1100. In the display area 1000, arrows 2 indicate the directions in which ions move. Hatched portions in FIG. 1 denote ion-aggregating locations 1 where ions aggregate. In FIG. 1, there are so many ion-aggregating locations 1 that the amount of ions aggregating at each location is insignificant, which precludes the occurrence of display unevenness.

The present disclosure proposes forming ion trap electrodes in the same layer as that of gate electrodes or scanning lines. At a location corresponding to each ion trap electrode, a common electrode opening is provided that traps ions in the liquid crystal. Inside the display area are numerous sets of the ion trap electrodes and the common electrode openings. This arrangement prevents ions from excessively aggregating at particular locations, thereby forestalling display unevenness. The present disclosure will now be described below in detail using specific embodiments.

### First Embodiment

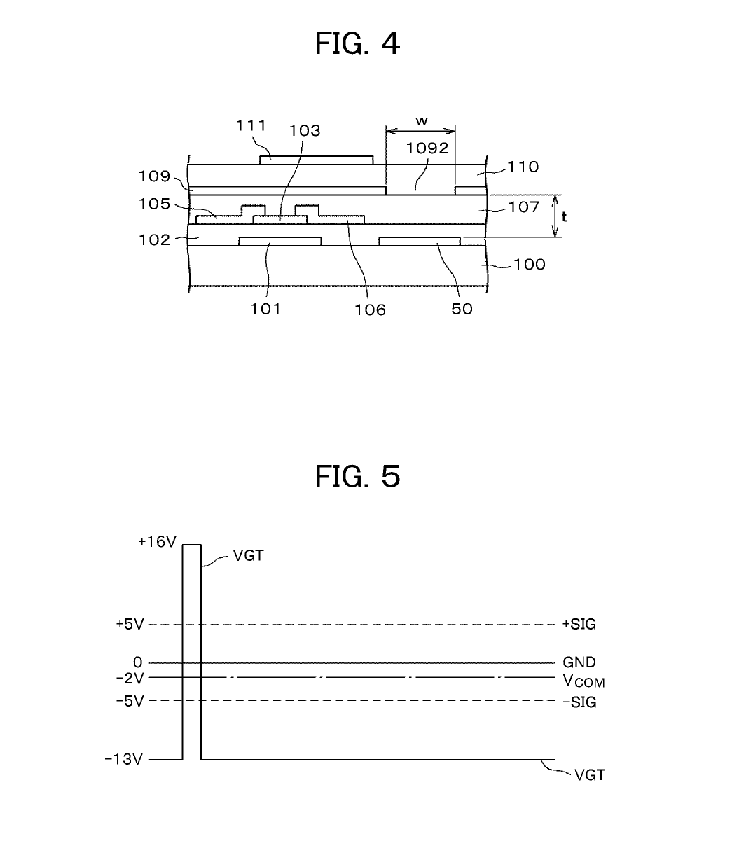

FIG. 4 is a cross-sectional view of a first embodiment of the present disclosure on the side of the TFT substrate 100. The first embodiment has bottom gate TFTs that use amorphous silicon in their switching elements. In FIG. 4, gate electrodes 101 are formed over the TFT substrate 100. A gate insulating film 102 is formed to cover the gate electrodes 101. An amorphous silicon semiconductor layer 103 is formed over the gate insulating film 102. A drain electrode 105 and a source electrode 106 formed over the semiconductor layer 103 constitute a TFT. An inorganic passivation film 107 is formed to cover the TFTs. A common electrode 109 is formed flat over the inorganic passivation film 107. A capacitance insulating film 110 is formed to cover the common electrode 109. Pixel electrodes 111 are formed over the capacitance insulating film 110. The pixel electrodes 111 have a slit structure. Alternatively, the pixel electrodes 111 may be shaped as a stripe each.

One characteristic of the structure in FIG. 4 is that ion trap electrodes 50 are formed in the same layer as that of the gate electrodes 101. The ion trap electrodes 50 are impressed with the same voltage as that for the gate electrodes 101. Each ion trap electrode 50 is matched with an opening 1092 of the common electrode 109. This allows the potential of the gate electrodes 101 to affect the liquid crystal layer.

Usually, the ion trap electrode 50 is formed to have a diameter larger than that of the common electrode opening 1092. In FIG. 4, the diameter of the common electrode opening 1092, represented by w, and the layer thickness between the ion trap electrode and the common electrode, represented by t, are preferably in a relationship defined as w≧t. In FIG. 4, for example, w=4 μm and t=1 μm.

FIG. 5 shows typical voltages to be impressed to the electrodes in amorphous silicon liquid crystal display devices such as one shown in FIG. 4. In FIG. 5, reference character GND represents ground potential, and reference characters +SIG and −SIG denote a positive maximum value and a negative maximum value of a video signal, respectively. The video signal has its polarity switched periodically when impressed to the pixel electrodes. Reference character Vcom stands for the voltage impressed to the common electrode, the impressed voltage being usually constant. Reference character VGT denotes the voltage impressed to the gate electrodes, the impressed voltage being usually −13 V. The voltage VGT is +16 V solely when impressed to turn on the TFTs.

The common electrode 109 at a location corresponding to each ion trap electrode 50 has the common electrode opening 1092 formed in that location. In the vicinity of the opening, the gate voltage of −13 V usually affects the liquid crystal layer. This causes positive ions to aggregate in the common electrode opening 1092. Because numerous sets of the ion trap electrodes 50 and common electrode openings 1092 are provided in the display area, ions do not aggregate excessively at any one location, with no display unevenness incurred. It is the positive ions that trigger display unevenness.

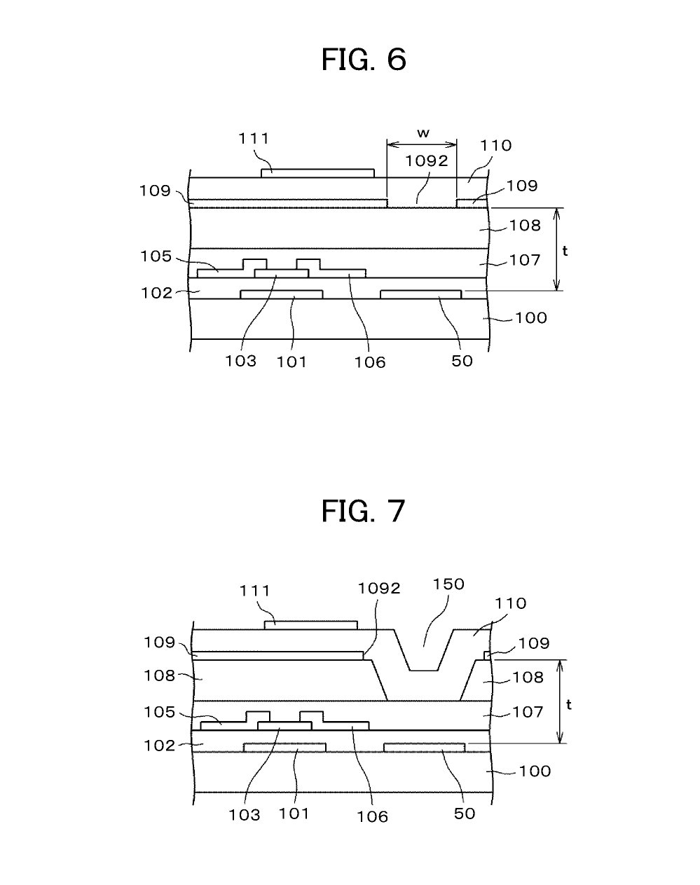

FIG. 6 shows a variation of the first embodiment involving bottom gate TFTs that use amorphous silicon in their switching elements. What makes the structure of FIG. 6 different from that of FIG. 4 is that an organic passivation film 108 is interposed between the common electrode 109 and the inorganic passivation film 107. The organic passivation film 108 is formed as thick as about 2 μm to double as a planarizing film. It follows that t=3 μm, which is smaller than w=4 μm.

FIG. 7 shows a structure in which the ion trap electrodes 50 affect the liquid crystal layer more strongly than the structure in FIG. 6. What makes the structure of FIG. 7 different from that of FIG. 6 is that through-holes are formed in the organic passivation film 108 over the ion trap electrodes 50, each through-hole being surrounded by the common electrode opening 1092. In the structure of FIG. 7, the potential of the ion trap electrodes 50 is allowed to affect the liquid crystal still more strongly. The holes to be made in the organic passivation film 108 may alternatively be recessed portions each formed halfway into the film, not through it.

In the structure of FIG. 7, through-holes are formed in the organic passivation film 108. Alternatively, the same effect is obtained by forming through-holes in some other film such as the gate insulating film 102, inorganic passivation film 107, or capacitance insulating film 110. In another alternative, instead of the through-holes being formed in the organic passivation film 108, part of the organic passivation film 108 may be removed in the thickness direction. Whereas in FIG. 7 each common electrode opening 1092 is formed to surround a through-hole, the common electrode opening 1092 may alternatively be formed inside each through-hole. Forming recessed portions 150 in this manner enables the ion trap electrodes 50 to affect the liquid crystal layer still more strongly and thereby causes positive ions to be attracted to the recessed portions more easily.

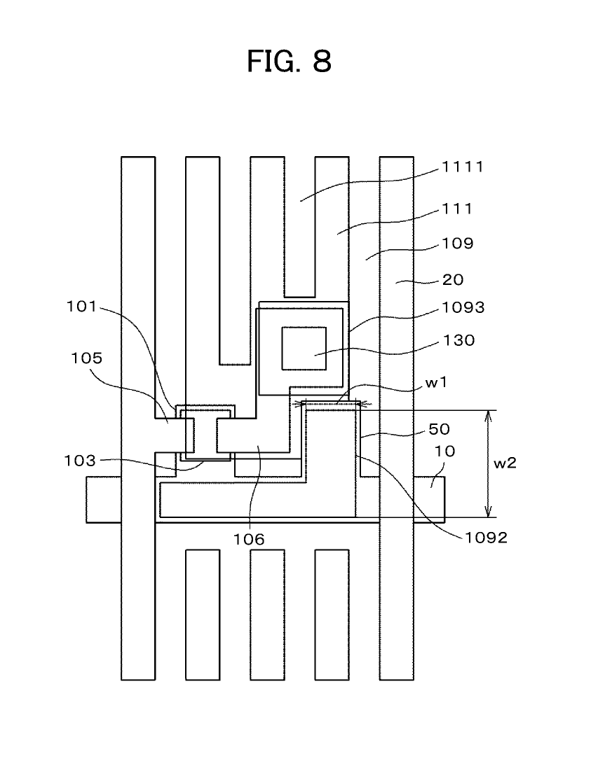

FIG. 8 is a plan view of a pixel area in the first embodiment. In FIG. 8, scanning lines 10 extend in a crosswise direction and are arrayed in a longitudinal direction. Video signal lines 20 extend in the longitudinal direction and are arrayed in the crosswise direction. Regions enclosed by the video signal lines 20 and the scanning lines 10 intersecting each other constitute pixels. In FIG. 8, each scanning line 10 branches off to form a TFT gate electrode 101. Over the gate electrodes 101, an amorphous silicon semiconductor layer 103 is formed. Over the semiconductor layer 103, there is a drain electrode 105 branching from each video signal line 20. A source electrode 106 is disposed opposite to each drain electrode 105. The source electrode 106 extends inside each pixel to connect with a pixel electrode 111 via a through-hole 130 formed in the inorganic passivation film 107.

The common electrode 109 is formed all over the inorganic passivation film 107. It should be noted that each through-hole 130 is surrounded by a common electrode opening 1093. A capacitance insulating film is formed to cover the common electrode 109. The pixel electrodes 111 each having slits 1111 are formed over the capacitance insulating film. In FIG. 8, the pixel electrode 111 has a comb-tooth-shaped structure with two slits. Where each pixel is appreciably small, it may be shaped as a single stripe.

In FIG. 8, each scanning line 10 branches off to form the ion trap electrode 50. The common electrode opening 1092 is formed in a manner overlapping with each ion trap electrode 50. The common electrode openings 1092 allow the potential of the ion trap electrodes 50, i.e., gate potential, to affect the liquid crystal layer, thereby attracting positive ions. In FIG. 8, the through-hole 130 is positioned inside each pixel to procure a space in which the ion trap electrode 50 is disposed.

As discussed above in reference to FIGS. 4, 6 and 7, the thickness t between the ion trap electrode and the common electrode and the diameter w of each common electrode opening are preferably in the relationship defined as w≧t. If the common electrode opening is a square or some other shape other than a circle, then the following applies: In FIG. 8, the common electrode opening 1092 has a diameter w1 on the side parallel with the scanning line 10 and a diameter w2 on the side perpendicular to the scanning line 10. These diameters are preferably in a relationship defined as w1≧t and w2≧t. The absolute values of the diameters w1 and w2 are preferably at least 3 μm each. If the common electrode opening 1092 is shaped to be elliptical for example, its diameters may be read as the axes parallel with and perpendicular to the scanning line 10. The above-mentioned diameters of the common electrode opening 1092 and the thickness t between the ion trap electrode 50 and the common electrode 109 are in relationships that also apply to the other drawings and embodiments to be discussed hereunder.

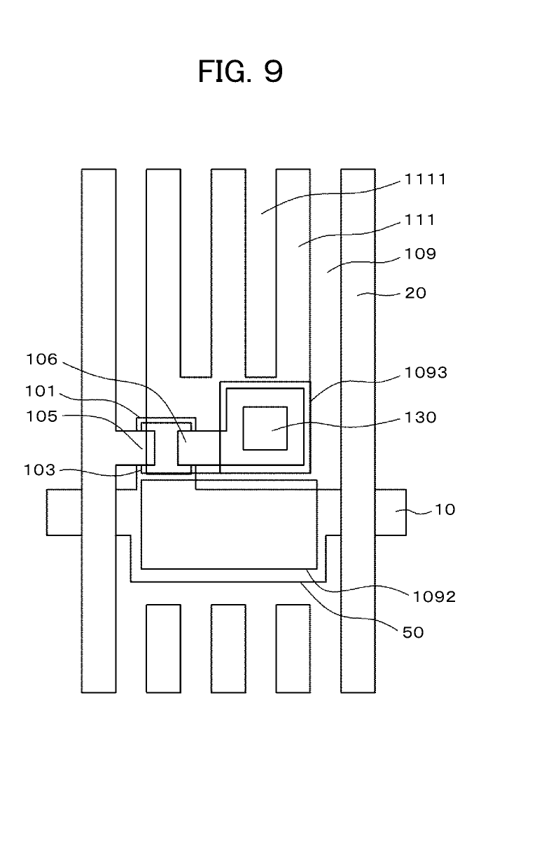

FIG. 9 is a plan view of a pixel area as still another variation of the first embodiment. What makes the structure of FIG. 9 different from that of FIG. 8 is that each scanning line 10 branches off to form an ion trap electrode 50 on the side of an adjacent pixel immediately below. With the ion trap electrode 50 thus shifted to the adjacent pixel, the through-hole 130 may be shifted to the side of the scanning line 10. The other specifics of the structure are the same as those in FIG. 8.

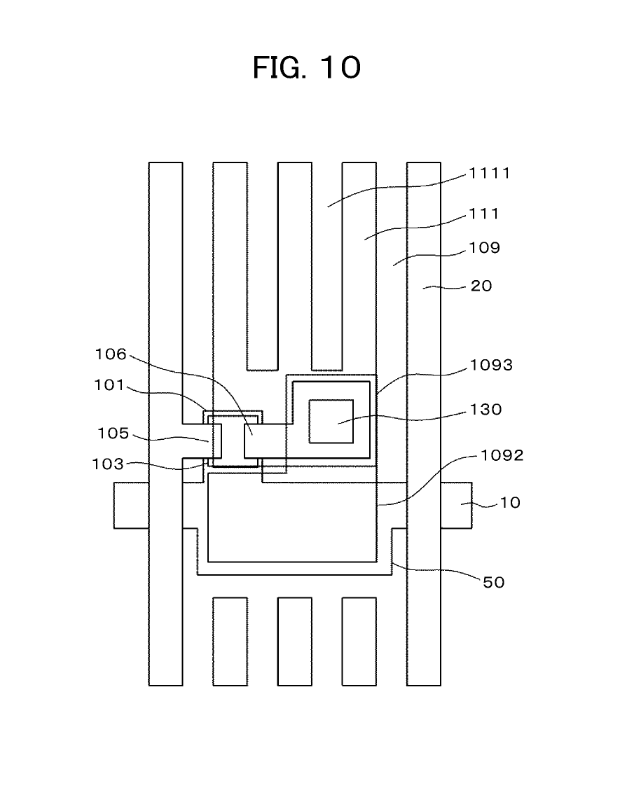

FIG. 10 is a plan view of a pixel area as still another variation of the first embodiment. The structure of FIG. 10 is similar to that of FIG. 9 except that a common electrode opening 1093 formed around each through-hole 130 is connected with a common electrode opening 1092 for each ion trap electrode. Where each pixel is significantly small in size, it is reasonable to adopt the structure such as one in FIG. 10.

### Second Embodiment

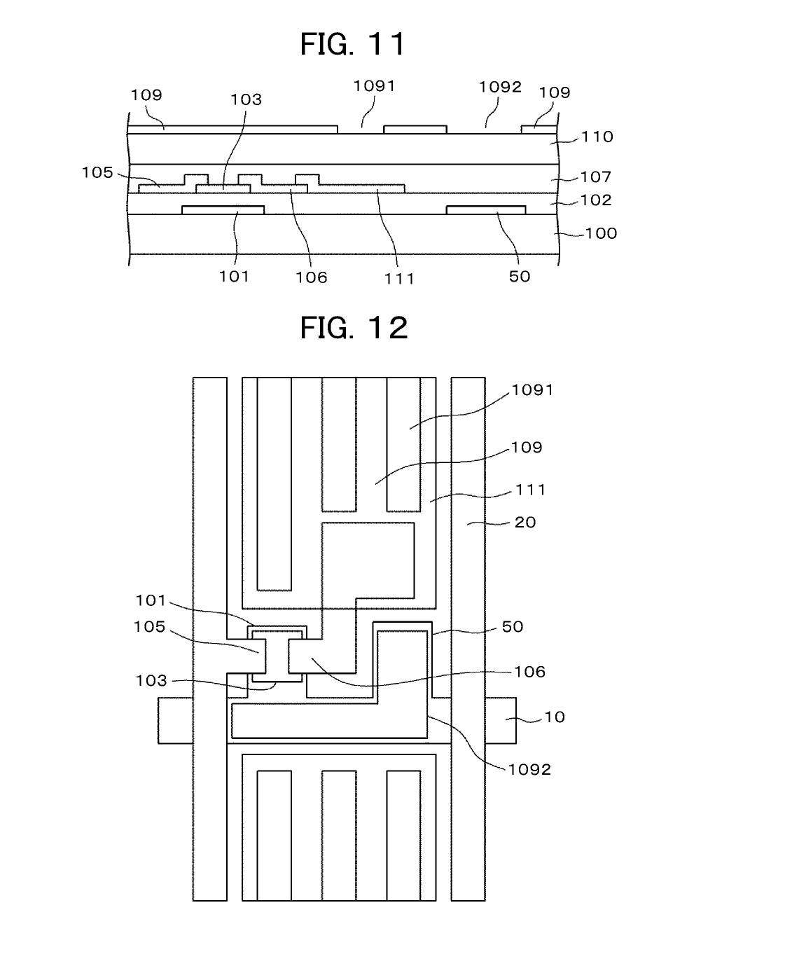

FIG. 11 is a cross-sectional view of a pixel area on the side of the TFT substrate 100 as a second embodiment of the present disclosure. The second embodiment involves bottom gate TFTs that use amorphous silicon in their switching elements. Unlike the first embodiment, the second embodiment has the common electrode 109 disposed over the pixel electrodes 111. The specifics of the structure up to the TFT configuration are the same as described above in reference to FIG. 4. In FIG. 11, the pixel electrode 111 is formed to overlap with the edge of each source electrode 106 disposed over the gate insulating film 102. It follows that there is no need for through-holes to connect the source electrodes 106 with the pixel electrodes 111. Hence the manufacturing process is simplified that much.

In FIG. 11, the inorganic passivation film 107 is formed to cover the TFTs. The capacitance insulating film 110 is formed over the inorganic passivation film 107. The common electrode 109 is formed over the capacitance insulating film 110. A voltage is impressed between the common electrode 109 and the pixel electrodes 111 connected directly with the source electrodes 106. The impressed voltage causes electric lines of force to extend into the liquid crystal layer via the slits 1091 of the common electrode 109. The resulting electric field twists liquid crystal molecules to control the transmittance of the pixels. In FIG. 11, the common electrode 109 may be formed over the inorganic passivation film 107 without the capacitance insulating film 110 being interposed therebetween.

In FIG. 11, the ion trap electrodes 50 are formed in the same layer as that of the gate electrodes 101. As in the first embodiment, the ion trap electrodes 50 are impressed with the gate voltage. Over each ion trap electrode 50, the common electrode 109 has a common electrode opening 1092 formed therein. Via the common electrode openings 1092, the voltage of the ion trap electrodes 50 affects the liquid crystal layer, causing positive ions to aggregate in the common electrode openings 1092.

FIG. 12 is a plan view of a pixel area in the second embodiment. In FIG. 12, the structure of the TFTs and that of the ion trap electrodes are the same as described above in connection with the first embodiment with reference to FIG. 8. In FIG. 12, each source electrode 106 over the TFT substrate extends toward the pixel electrode 111. Each pixel electrode 111 is connected to the source electrode 106 in a manner directly overlapping therewith without the intervention of a through-hole.

Each pixel electrode 111 is formed to be rectangular in shape. In FIG. 12, the common electrode 109 covering the entire pixels has slits 1091 formed over each pixel electrode. It is through these slits 1091 that the liquid crystal is driven. The common electrode 109 has the common electrode opening 1092 formed over each ion trap electrode 50. Via the common electrode openings 1092, the gate voltage affects the liquid crystal layer, causing positive ions to aggregate.

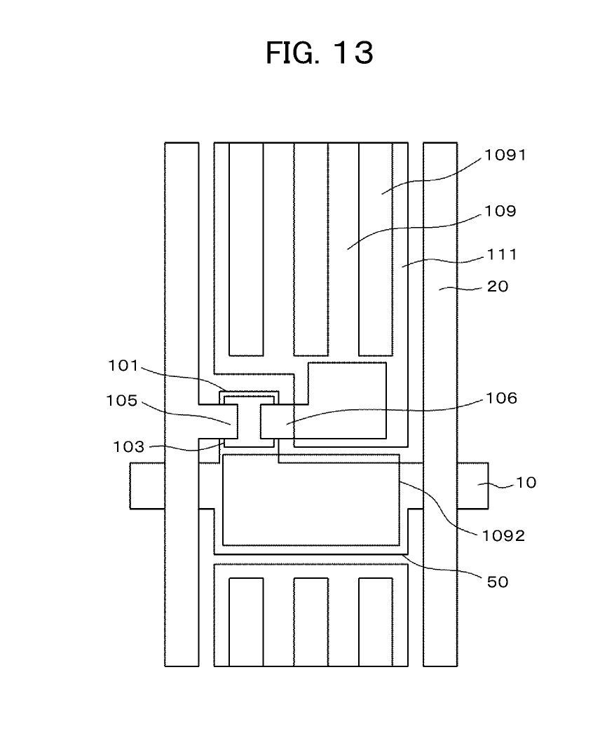

FIG. 13 is a plan view of a pixel area as a variation of the second embodiment. In FIG. 13, the layer structure of the TFTs and that of the electrodes are the same as described above in reference to FIG. 12. What makes the structure of FIG. 13 different from that of FIG. 12 is that each ion trap electrode 50 is formed in an adjacent pixel immediately below. Thus the portion of each pixel where the source electrode 106 overlaps with the pixel electrode 111 is positioned that much closer to the scanning line 10. The other specifics of the structure are the same as described above in reference to FIG. 12.

In the second embodiment, numerous ion trap electrodes 50 and common electrode openings 1092 are also formed in the display area. This makes it possible to prevent positive ions from aggregating excessively at any one location, thereby forestalling display unevenness.

### Third Embodiment

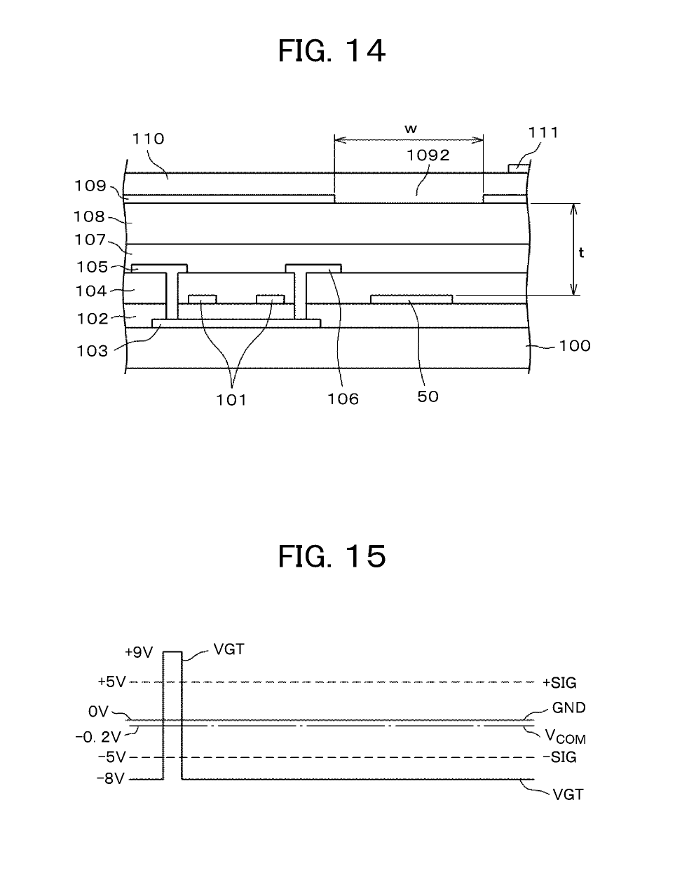

A third embodiment of the present disclosure involves using top-gate type TFTs that use poly-silicon as switching TFTs. FIG. 14 is a cross-sectional view of a pixel area as the third embodiment. In FIG. 14, a poly-silicon semiconductor layer 103 is formed over the TFT substrate 100. A gate insulating film 102 is formed to cover the semiconductor layer 103. Over the gate insulating film 102 corresponding to the semiconductor layer 103, two gate electrodes are formed in parallel with each other to constitute a double-gate structure.

An interlayer insulating film 104 is formed to cover the gate electrodes 101. Drain electrodes 105 and source electrodes 106 are formed over the interlayer insulating film 104, each of the electrodes being connected to the semiconductor layer 103 via a through-hole. An inorganic passivation film 107 is formed to cover the drain electrodes 105 and source electrodes 106. An organic passivation film 108 is formed over the inorganic passivation film 107. The organic passivation film 108 is formed as thick as about 2 μm to double as a planarizing film. A common electrode 109 is formed over the organic passivation film 108. A capacitance insulating film 110 is formed to cover the common electrode 109. Pixel electrodes 111 are formed over the capacitance insulating film 110.

In FIG. 14, ion trap electrodes 50 are formed in the same layer as that of the gate electrodes 101 over the gate insulating film 102. The common electrode 109 disposed over the organic passivation film 108 has a common electrode opening 1092 formed above each ion trap electrode. Via the common electrode openings 1092, the potential of the ion trap electrodes, i.e., gate potential, affects the liquid crystal layer and thereby causes positive ions to aggregate in the openings 1092. In the third embodiment, too, the layer thickness t between each ion trap electrode 50 and the common electrode 109 and the diameter w of each common electrode opening 1092 are preferably in the relationship defined as w≧t. In FIG. 14, w=5 μm and t=4 μm for example.

FIG. 15 shows typical voltages to be impressed to the electrodes where poly-silicon-based top gate TFTs are provided. In FIG. 15, reference character GND represents ground potential, and reference characters +SIG and −SIG denote a positive maximum value and a negative maximum value of a video signal, respectively. The video signal has its polarity switched periodically when impressed to the pixel electrodes. Reference character Vcom stands for the voltage impressed to the common electrode, the impressed voltage being usually constant. Reference character VGT denotes the voltage impressed to the gate electrodes, the impressed voltage being usually −8 V. The voltage VGT is +9 V solely when impressed to turn on the TFTs.

The portion of the common electrode 109 corresponding to each ion trap electrode 50 forms a common electrode opening 1092. In the vicinity of the common electrode openings 1092, the gate voltage that is usually −8 V affects the liquid crystal layer, causing positive ions to aggregate. However, numerous sets of the ion trap electrodes 50 and common electrode openings 1092 are provided in the display area, so that ions do not aggregate excessively at any one location. This forestalls display unevenness.

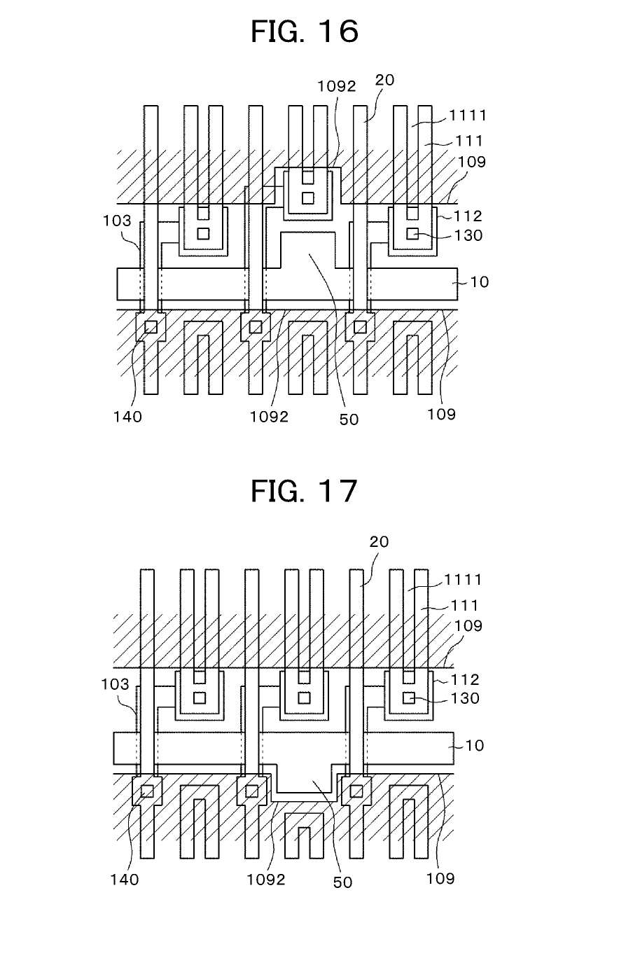

FIG. 16 is a plan view of pixels in the third embodiment. Unlike in FIG. 14, the TFTs in FIG. 16 have a single-gate structure. Liquid crystal display devices that adopt poly-silicon TFTs are often used to build screens whose resolution is higher than when amorphous silicon TFTs are employed. In FIG. 16, the dimensions of each pixel as in FIG. 2B are x=20 μm and y=60 μm, for example.

In FIG. 16, scanning lines 10 extend in the crosswise direction and are arrayed in the longitudinal direction. Video signal lines 20 extend in the longitudinal direction and are arrayed in the crosswise direction. In FIG. 16, the semiconductor layer 103 is connected to the video signal lines 20 via through-holes 140. The semiconductor layer 103 extends under each video signal line 20 to pass below the scanning line 10. At this point, the scanning line 10 forms a gate electrode 101 to make up a TFT. The semiconductor layer 103 further extends under each video signal line 20, before bending to connect with a contact electrode 112. The contact electrodes 112 are formed in the same layer as that of the video signal lines 20. The through-holes for connecting the semiconductor layer 103 to the contact electrodes 112 are not shown in FIG. 16.

The contact electrodes 112 are connected to the pixel electrodes 111 via through-holes 130. The pixel electrodes 111 are comb-tooth-shaped electrodes having slits 1111. Where each pixel is small, the pixel electrode 111 may be shaped as a single stripe. Under the pixel electrodes 111 are flat-shaped common electrodes 109 with a capacitance insulating film interposed therebetween. The common electrodes 109 are made up of upper and lower flat-shaped electrodes with the scanning lines 10 interposed therebetween.

In FIG. 16, the scanning line 10 branches off to form a projecting ion trap electrode 50. Each projecting ion trap electrode 50 is matched with a recessed common electrode opening 1092. The common electrode openings 1092 thus formed enable the potential of the ion trap electrodes 50 to better affect the liquid crystal layer above. Of the three pixels in FIG. 16, the pixel in the middle has the scanning line 10 branching off to form a projecting ion trap electrode 50. Consequently, the center pixel has its through-hole 130 formed more inside than the other pixels.

In FIG. 16, there is no common electrode 109 over the scanning line 10. However, when viewed in a plan view, the scanning line 10 and the common electrode 109 are close to each other, so that the electric lines of force from the scanning line 10 are terminated by the common electrode 109 and barely affect the liquid crystal layer. For this reason, the effect of aggregating positive ions in the liquid crystal layer is mostly attributable to the ion trap electrodes 50 and to the corresponding common electrode openings 1092.

FIG. 17 is a plan view of pixels as a variation of the third embodiment. What makes the structure of FIG. 17 different from that of FIG. 16 is that in FIG. 17, the ion trap electrode 50 is formed on the side of an adjacent pixel immediately below. Thus the corresponding common electrode opening 1092 is also formed in the adjacent pixel immediately below. In this variation of the third embodiment, too, the effect of aggregating positive ions in the liquid crystal layer is mostly attributable to the ion trap electrodes 50 and to the corresponding common electrode openings 1092.

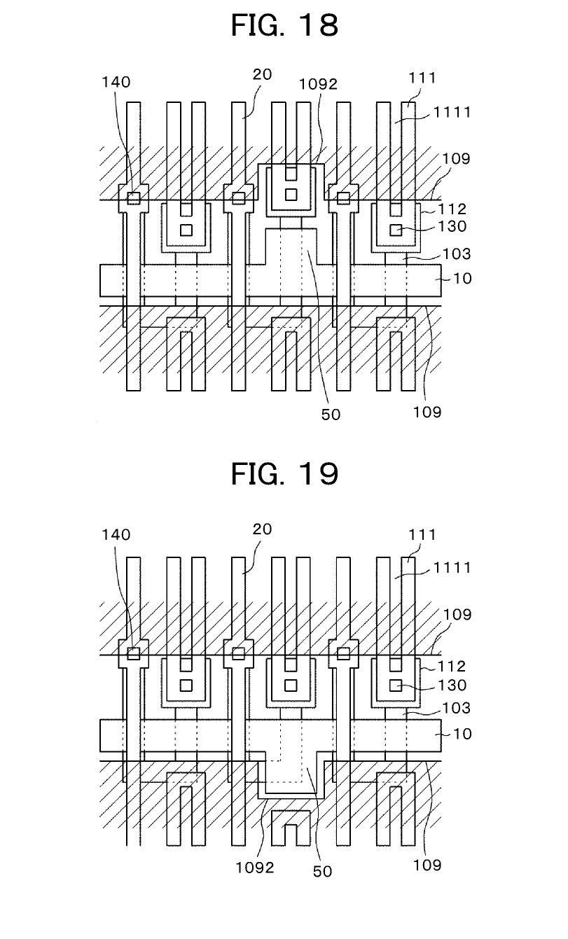

FIG. 18 is a plan view of another variation of the third embodiment. FIG. 18 illustrates a double-gate TFT structure. In FIG. 18, the semiconductor layer 103 is connected to the video signal lines 20 via the through-holes 140. The semiconductor layer 103 extends under each video signal line 20 to pass below the scanning line 10. At this point, a first TFT is formed. The semiconductor layer 103 then bends to again pass under the scanning line 10 to form a second TFT. The second TFT has a long channel because the scanning line 10 and the ion trap electrode 50 are formed into a gate electrode. Thereafter, the semiconductor layer 103 extends up to under the contact electrode 112 to connect with the latter. Each contact electrode 112 is connected to the pixel electrode via the through-hole 130.

Each common electrode opening 1092 is formed corresponding to where there exists an ion trap electrode 50 branching from the scanning line 10. The semiconductor layer 103 solely passing under the ion trap electrodes 50 does not affect their workings. Thus as discussed above in reference to FIG. 16, the potential of the ion trap electrodes 50 affects the liquid crystal layer, causing positive ions to aggregate.

FIG. 19 is a plan view of pixels as still another variation of the third embodiment. FIG. 19 also shows a double-gate TFT structure. The second TFT has a long channel as in the structure of FIG. 18. In FIG. 19, each ion trap electrode 50 branching from the scanning line 10 is formed in an adjacent pixel immediately below. Each common electrode opening 1092 is also formed in the adjacent pixel immediately below. The other structures and workings are the same as those described above in reference to FIG. 18.

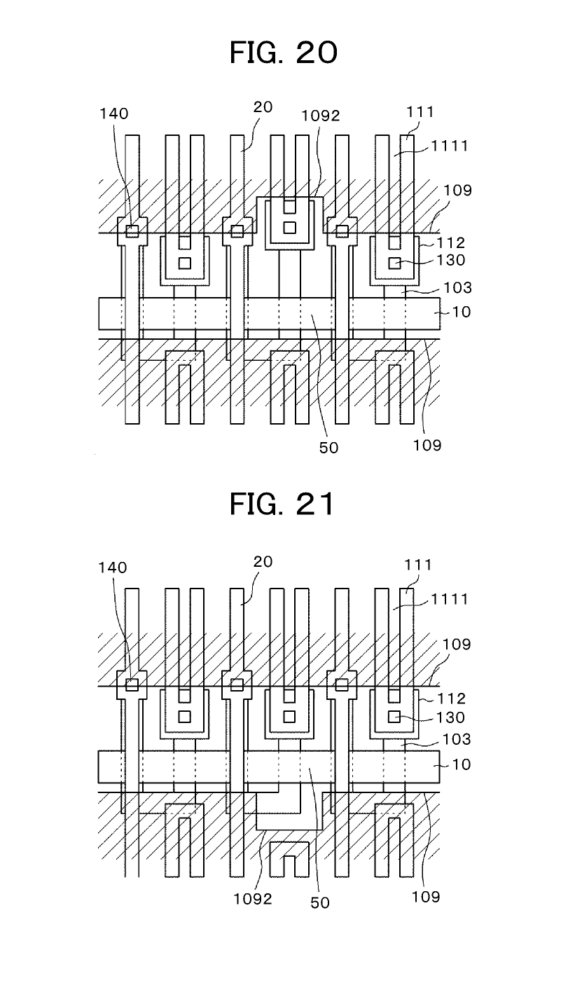

FIG. 20 is a plan view of pixels as still another variation of the third embodiment. What makes the structure of FIG. 20 different from that of FIG. 18 is that there is no ion trap electrode branching from the scanning line 10. The absence of the ion trap electrodes branching from the scanning lines 10 means that the channel length of the second TFT is the same as that of the first TFT.

However, with no ion trap electrode branching from the scanning line 10, the common electrode openings 1092 are still formed. Correspondingly, each contact electrode 112 is formed more inside the pixel than the common electrode opening 1092. The absence of ion trap electrodes branching from the scanning lines 10 still allows the electric fields of the scanning lines 10 to easily affect the liquid crystal layer because of the common electrode openings 1092 being present. That is, in FIG. 20, parts of the scanning lines 10 play the role of the ion trap electrodes. Thus the structure of FIG. 20 allows positive ions to aggregate in the common electrode openings 1092.

FIG. 21 is a plan view of a pixel area as still another variation of the third embodiment. What makes the structure of FIG. 21 different from that of FIG. 20 is that each common electrode opening 1092 is formed on the side of an adjacent pixel immediately below. The other specifics of the structure are the same as those in FIG. 20. In FIG. 21, the channel length of the second TFT is also allowed to be the same as that of the first TFT. And as in FIG. 20, positive ions are caused to aggregate in the common electrode openings 1092.

### Fourth Embodiment

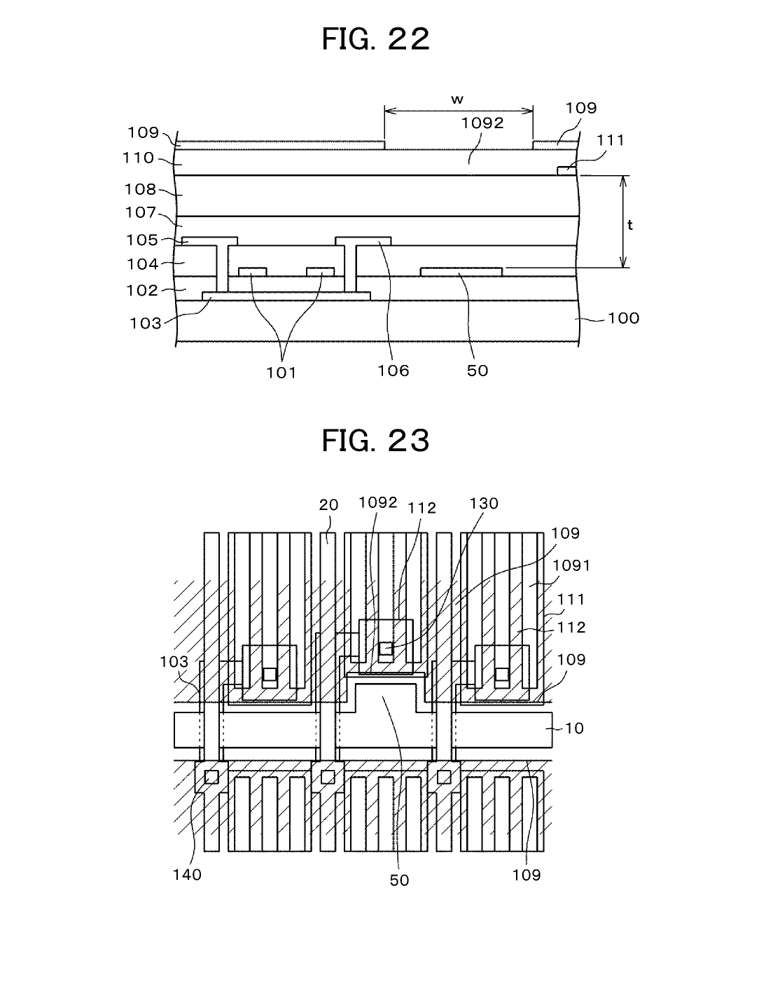

FIG. 22 is a cross-sectional view of a pixel area as a fourth embodiment of the present disclosure. The fourth embodiment also involves adopting top-gate type TFTs that use poly-silicon as switching TFTs. The fourth embodiment has a so-called common-top type IPS structure in which the common electrode 109 is disposed above pixel electrodes 111. That is, the structure leading up to the organic passivation film is the same as the structure in FIG. 14.

In FIG. 22, the pixel electrodes 111 are formed over an organic passivation film 108. A capacitance insulating film 110 is formed to cover the pixel electrodes 111. The common electrode 109 is formed over the capacitance insulating film 110. At a location corresponding to each ion trap electrode 50 formed over the gate insulating film 102, a common electrode opening 1092 is formed. In the fourth embodiment, too, the layer thickness t between each ion trap electrode 50 and the common electrode 109 and the diameter w of each common electrode opening 1092 are preferably in the relationship defined as w≧t. Typical voltages impressed to the electrodes in the fourth embodiment are the same as those discussed above in conjunction with the third embodiment in reference to FIG. 15.

FIG. 23 is a plan view of pixels as the fourth embodiment. FIG. 23 shows a single-gate TFT structure that is the same as described above in reference to FIG. 16. What makes the structure of FIG. 23 different from that of FIG. 16 is that the pixel electrode 111 is formed to be rectangular in each pixel and connected to the contact electrode 112 and that the common electrode 109 is formed over the pixel electrodes 111 with the capacitance insulating film 110 interposed therebetween. In FIG. 23, the slits 1091 of the common electrode 109 are formed corresponding to each pixel electrode 111. The electric lines of force passing through the slits 1091 control liquid crystal molecules.

In FIG. 23, upper and lower common electrodes 109 are formed flat in a manner sandwiching the scanning lines 10 therebetween. Each ion trap electrode 50 branches from the scanning line 10. The common electrodes 109 have a recessed opening 1092 of the common electrode 109 formed in a manner corresponding to each ion trap electrode 50. The potential of the ion trap electrodes 50 affects the liquid crystal layer via the recessed common electrode openings 1092, causing positive ions to aggregate in the common electrode openings 1092. The other workings of the structure are the same as those described above in reference to FIG. 16.

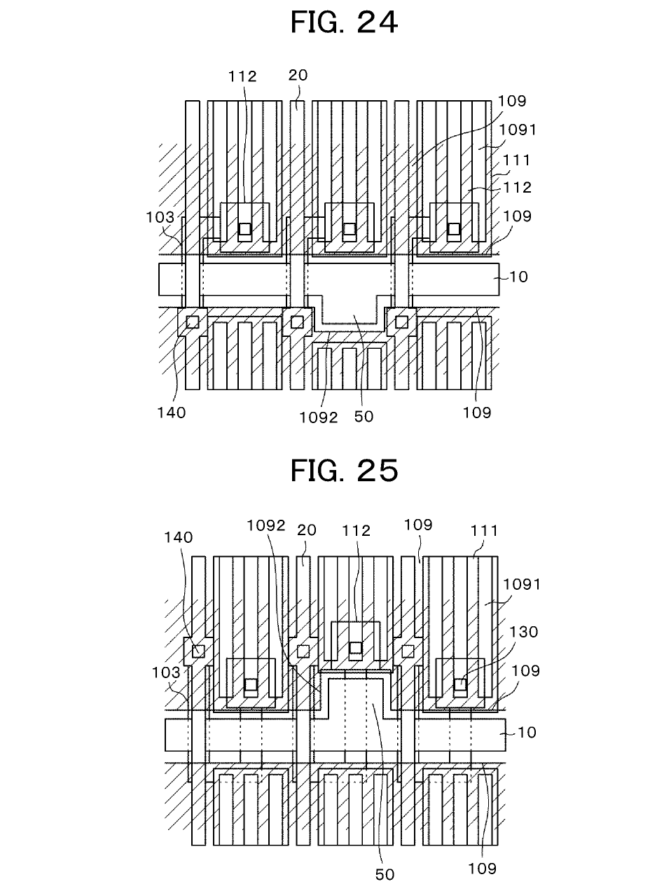

FIG. 24 is a plan view of a variation of the fourth embodiment. What makes the structure of FIG. 24 different from that of FIG. 23 is that each ion trap electrode 50 branching from the scanning line 10 is formed in an adjacent pixel immediately below. A recessed opening 1092 of the common electrode 109 is formed corresponding to each ion trap electrode 50. The ion trap electrodes 50 and the common electrode openings 1092 combine to let positive ions in the liquid crystal aggregate in the openings 1092. The other structures and workings are the same as those described above in reference to FIG. 23.

FIG. 25 is a plan view of a pixel area as another variation of the fourth embodiment. In FIG. 25, upper and lower common electrodes 109 are formed flat in a manner sandwiching the scanning lines 10 therebetween. The common electrodes 109 have slits 1091 at a location corresponding to each pixel electrode 111. This variation of the fourth embodiment has a double-gate TFT structure that is the same as described above in reference to FIG. 18. The workings of the ion trap electrodes 50 and the common electrode openings 1092 formed in the common electrodes 109 are the same as described above in reference to FIG. 18.

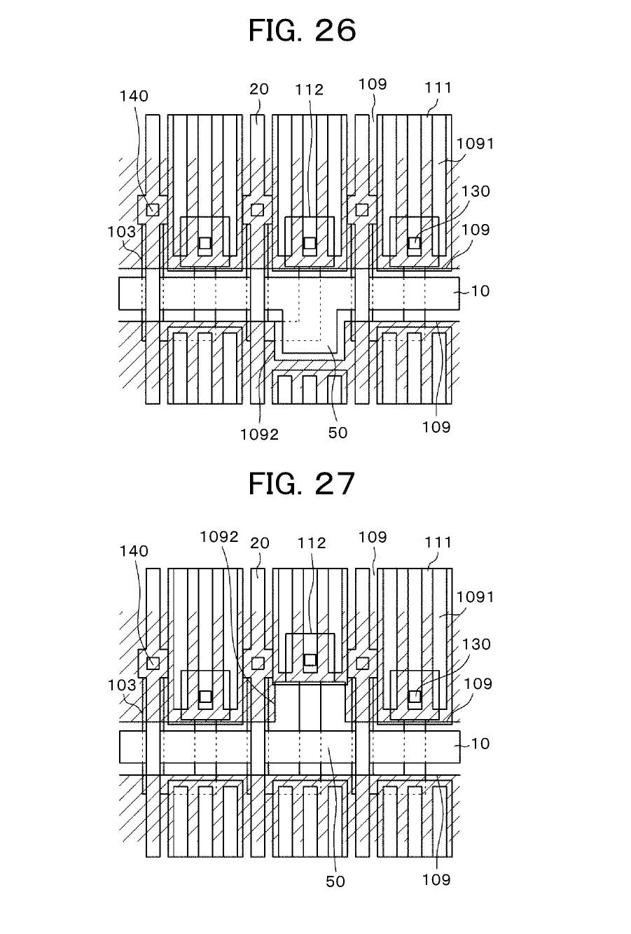

FIG. 26 is a plan view of a pixel area as still another variation of the fourth embodiment. What makes the structure of FIG. 26 different from that of FIG. 25 is that each ion trap electrode 50 is formed in an adjacent pixel immediately below and that a recessed common electrode opening 1092 corresponding to each ion trap electrode 50 is also formed in the adjacent pixel immediately below. The pixel electrodes 111 and the common electrodes 109 are in the same relationship described above in reference to FIG. 23. The double-gate TFT structure is the same as described above in reference to FIG. 19. The workings of the ion trap electrodes 50 and common electrode openings 1092 are also the same as discussed above in reference to FIG. 19.

FIG. 27 is a plan view of a pixel area as still another variation of the fourth embodiment. What makes the structure of FIG. 27 different from that of FIG. 25 is that although there is no ion trap electrode 50 branching from the scanning line 10, recessed common electrode openings 1092 are still formed in the common electrode 109. The workings of this structure are the same as described above in reference to FIG. 20. This variation of the fourth embodiment thus allows positive ions to aggregate in the common electrode openings 1092 in the same manner as in the structure in FIG. 20 or 25.

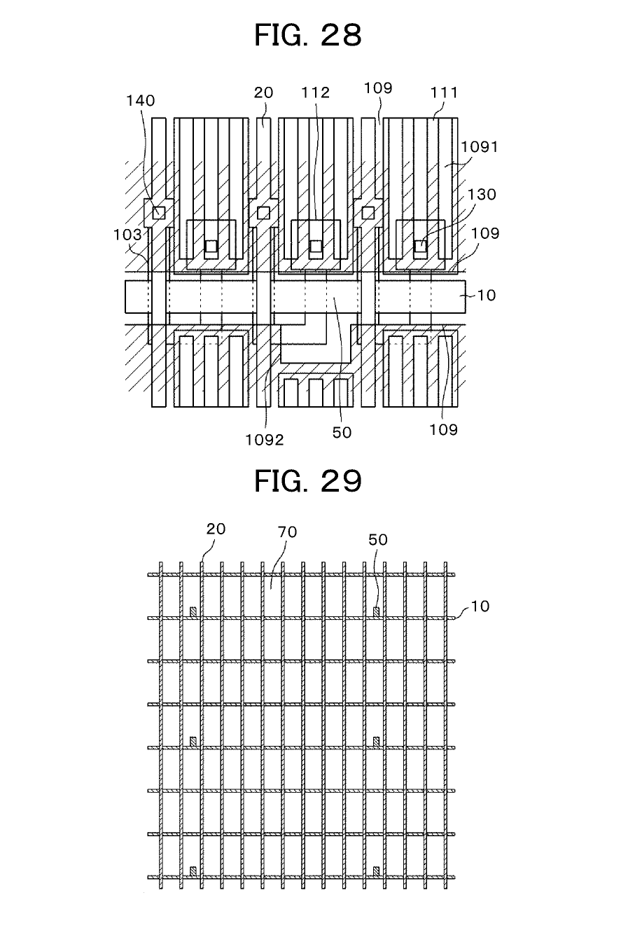

FIG. 28 is a plan view of a pixel area as still another variation of the fourth embodiment. What makes the structure of FIG. 28 different from that of FIG. 26 is that although there are no ion trap electrodes 50 branching from the scanning lines 10, the common electrode 109 has a common electrode opening 1092 formed in an adjacent pixel immediately below. The workings of this structure are the same as described above in reference to FIG. 21. This variation of the fourth embodiment also allows positive ions to aggregate in the common electrode openings 1092 in the same manner as in the structure in FIG. 21 or 26.

### Fifth Embodiment

The ion trap electrodes 50 need not be formed in all pixels. FIG. 29 shows an example in which the ion trap electrode 50 is located at intervals of 9 pixels in the crosswise direction and at intervals of 3 pixels in the longitudinal direction. The ion trap electrodes 50 are formed with the same metal as that of the scanning lines 10, so that they make up light-shielding regions.

Columnar spacers 60 are formed over the counter substrate 200 so as to determine the gap between the TFT substrate 100 and the counter substrate 200. The portions where the columnar spacers 60 are located incur light leaks because of the liquid crystal alignment being disturbed there. In order to prevent degradation of display contrast due to light leaks, the portions where the columnar spacers 60 are formed are provided with a black matrix 201.

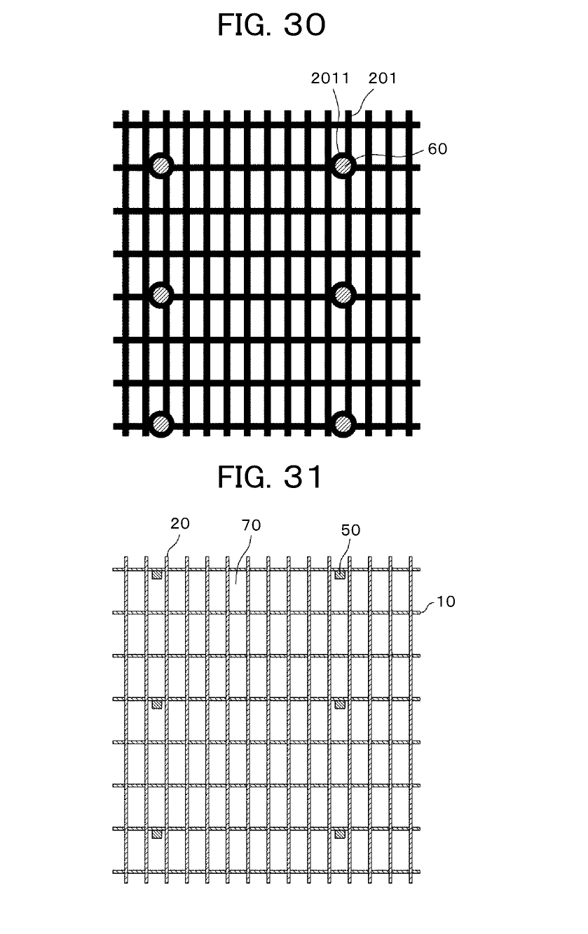

One characteristic of the fifth embodiment is that the portions where the columnar spacers 60 are formed are allowed to overlap with the portions where the ion trap electrode 50 are formed on the side of the TFT substrate 100, thereby minimizing the decrease of light transmittance. FIG. 29 is a plan view showing the side of the TFT substrate 100, with each ion trap electrode 50 formed in the own pixel. FIG. 30 is a plan view showing how the black matrix 201 and the columnar spacers 60 are positioned on the side of the counter substrate 200.

The black matrix 201 is formed corresponding to the scanning lines 10 and the video signal lines 20 disposed over the TFT substrate 100. The black matrix has a wider portion 2011 where the columnar spacers 60 are formed. This structure is intended to prevent light leaks that may occur via the columnar spacers 60. The columnar spacers 60 in FIG. 30 and the ion trap electrodes 50 in FIG. 29 are formed to coincide with each other in position when the TFT substrate 100 and the counter substrate 200 are disposed opposite to one another.

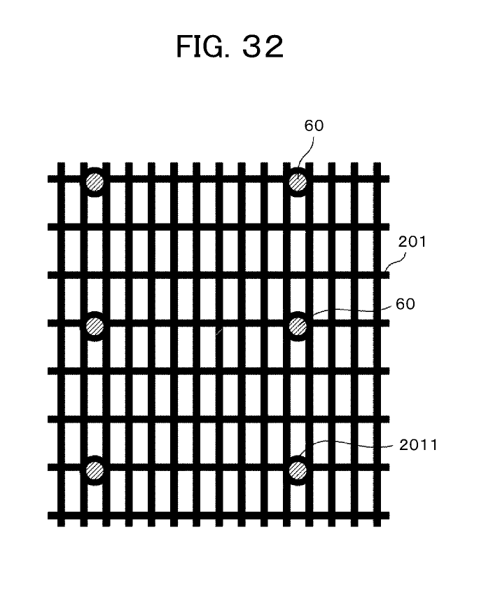

FIG. 31 shows a typical structure in which each ion trap electrode 50 is formed in an adjacent pixel immediately below on the side of the TFT substrate 100. The other specifics of the structure are the same as those in FIG. 29. FIG. 32 shows an example in which the black matrix 201 and the columnar spacers 60 are formed on the side of the counter substrate 200. The columnar spacers 60 and the wider portion 2011 of black matrix corresponding thereto are formed to coincide in position with the ion trap electrodes 50 on the side of the TFT substrate 100 when the TFT substrate 100 and the counter substrate 200 are disposed opposite to one another.

As described above, the fifth embodiment of the present disclosure prevents display unevenness while forestalling the decrease of screen brightness.

### Sixth Embodiment

As display resolution is progressively enhanced, the pixel size is further diminished. For example, the pixel dimensions shown in FIG. 2B may be x=15 μm and y=45 μm or thereabouts. When each pixel is of such a small size, it is difficult to procure inside the pixel a space for accommodating the ion trap electrode 50 and the columnar spacer 60. In view of this, a sixth embodiment of the present disclosure involves procuring, at predetermined intervals of pixels, a portion where the pixel electrode 111 and the TFT are absent and the ion trap electrode 50 and the columnar spacer 60 are disposed in their place.

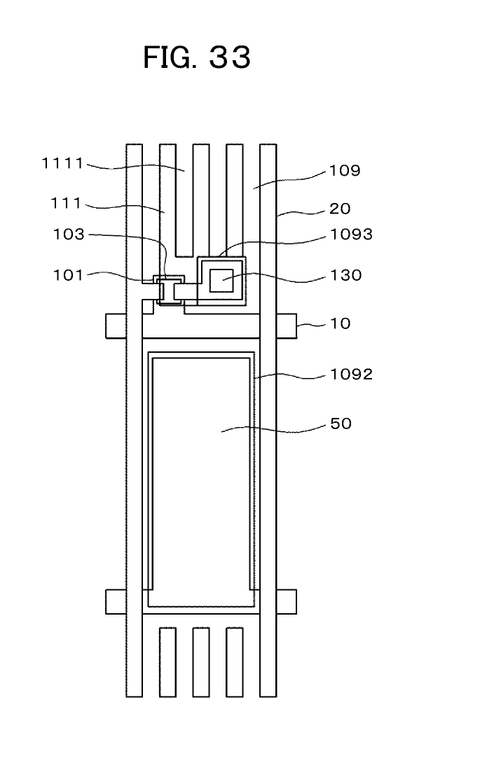

FIG. 33 is a plan view showing a typical pixel in which the pixel electrode 111 is not formed. In FIG. 33, an ion trap electrode 50 branches from the scanning line 10 to occupy the entire pixel. A common electrode opening 1092 is formed corresponding to the ion trap electrode 50. The adjacent pixels immediately above, below, right and left are ordinary pixels. On a high-resolution screen, the pixel size is so small that disabling a single pixel hardly affects image quality.

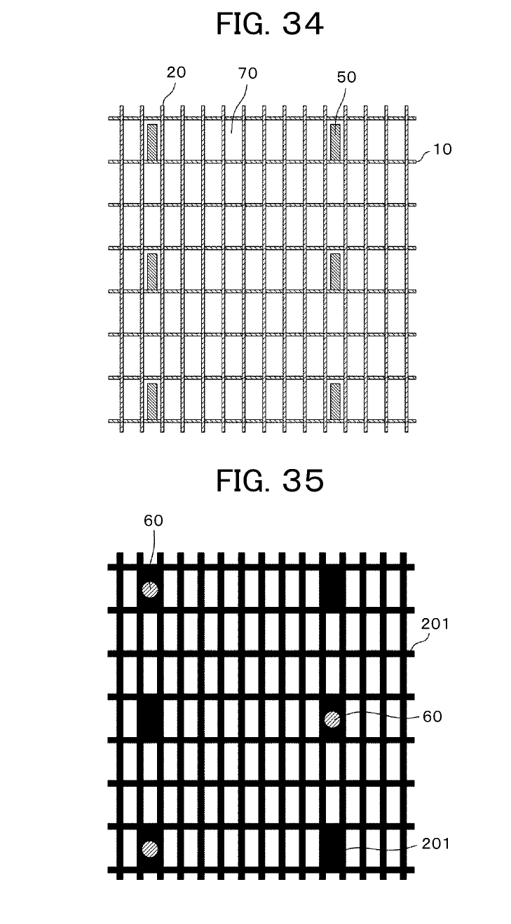

FIG. 34 is a plan view showing an arrangement of pixels each being an ion trap electrode 50 in its entirety (ion trap electrode pixels) on the side of the TFT substrate 100. In FIG. 34, the ion trap electrode 50 is located at intervals of 9 pixels in the crosswise direction and at intervals of 3 pixels in the longitudinal direction. It is preferred, however, that the ion trap electrode pixels be arrayed in a manner leaving the color balance of the screen intact.

On the counter substrate side, pixels each being blacked out by a black matrix (black matrix pixels) are formed corresponding to the ion trap pixels. Columnar spacers 60 are also formed, each corresponding to a plurality of black matrix pixels. This structure minimizes the decrease of light transmittance attributable to the columnar spacers.

### Seventh Embodiment

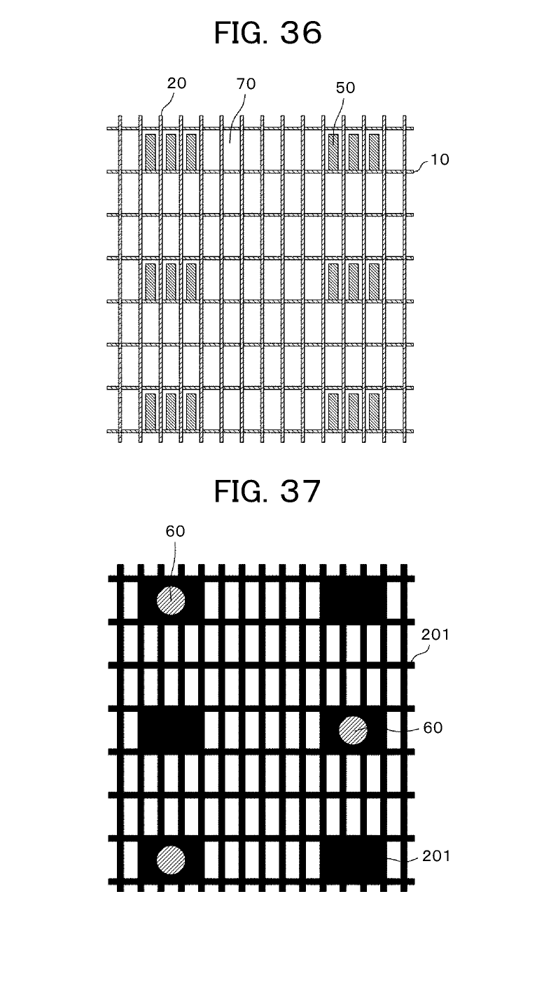

As display resolution is further enhanced, it may become difficult for each pixel to accommodate an ion trap electrode 50 and a columnar spacer 60. In that case, an entire set of a red pixel, a green pixel and a blue pixel may be arranged into an ion trap electrode 50. FIG. 36 shows a typical arrangement of the ion trap electrodes 50 each structured as such, on the side of the TFT substrate 100. In FIG. 36, a pixel set formed of only three ion trap electrodes 50 (ion trap electrode pixel set) is located at intervals of 3 sets in the crosswise direction and at intervals of 3 sets in the longitudinal direction, for example.

FIG. 37 shows an example where pixel sets each formed of three contiguous pixels and blacked out by a black matrix (black matrix pixel sets) are disposed on the side of the counter substrate 200 in a manner corresponding to the TFT substrate 100. In FIG. 37, some of the black matrix pixel sets are provided with a columnar spacer 60 each. This structure minimizes the decrease of light transmittance attributable to the columnar spacers 60.

If each pixel is provided with an ion trap electrode pixel or a black matrix pixel, there is a danger of incurring color unevenness. The above-described seventh embodiment of the present disclosure involves forming the ion trap electrodes or the back matrix as pixel sets. This structure prevents the occurrence of color unevenness.

It was explained above that three pixels are arranged into a single set. Alternatively, two pixels or four pixels may be arranged into one set. In such cases, the ion trap electrode pixel sets need only be arranged in a manner maintaining color balance. Although this specification describes IPS liquid crystal display devices including fringe-field-switching (FFS) devices, this is not limitative of the present disclosure. Alternatively, the present disclosure can be applied to liquid crystal display devices operating on methods using vertical electric fields such as the vertical alignment (VA) method and twisted nematic (TN) method, or other methods utilizing oblique electric fields.

What is claimed is:

1. A liquid crystal display device comprising a thin-film transistor (TFT) substrate and a counter substrate disposed opposite to the TFT substrate, the TFT substrate having a scanning line, a video signal line, and a TFT, the TFT connected to the scanning line and the video signal line, the TFT substrate and the counter substrate sandwiching liquid crystal;
wherein the TFT substrate has a pixel electrode connected to the TFT, an insulating film, and a counter electrode disposed opposite to the first electrode with the insulating film, the TFT substrate further having a conductive layer formed in the same layer as the scanning line; and
wherein the counter electrode has an opening formed between the conductive layer and the liquid crystal.

2. The liquid crystal display device according to claim 1, wherein the opening has a first diameter parallel to a direction in which the scanning line extends and a second diameter perpendicular to the scanning line extending direction, the first diameter represented by w1, the second diameter represented by w2, and the distance measured between the conductive layer and the counter electrode and represented by t, are in a relationship defined as w1≧t and w2≧t.

3. The liquid crystal display device according to claim 1, wherein the conductive layer is formed perpendicular to the scanning line extending direction and in a manner protruding into the pixel.

4. The liquid crystal display device according to claim 1, wherein a recessed portion is formed in the insulating film, between the conductive layer and the opening.

5. The liquid crystal display device according to claim 2, wherein a recessed portion is formed in the insulating film, between the conductive layer and the opening.

6. The liquid crystal display device according to claim 3, wherein a recessed portion is formed in the insulating film, between the conductive layer and the opening.

7. The liquid crystal display device according to claim 1, wherein the conductive layer is part of the scanning line.

8. The liquid crystal display device according to claim 2, wherein the conductive layer is part of the scanning line.

9. The liquid crystal display device according to claim 3, wherein the conductive layer is part of the scanning line.

10. The liquid crystal display device according to claim 4, wherein the conductive layer is part of the scanning line.

11. The liquid crystal display device according to claim 5, wherein the conductive layer is part of the scanning line.

12. The liquid crystal display device according to claim 1, wherein the pixel electrode is between the counter electrode and the liquid crystal.

13. The liquid crystal display device according to claim 1, wherein the counter electrode is between the pixel electrode and the liquid crystal.

14. The liquid crystal display device according to claim 1, wherein the TFT has a semiconductor layer formed of amorphous silicon.

15. The liquid crystal display device according to claim 1, wherein the TFT has a semiconductor layer formed of poly-silicon.

16. The liquid crystal display device according to claim 1, wherein the gap between the TFT substrate and the counter substrate is determined by a spacer disposed in a pixel in which the conductive layer is formed.

17. The liquid crystal display device according to claim 16, wherein a plurality of the pixels are formed in a matrix pattern, some of the pixels each having the counter electrode formed therein to occupy the entire pixel.

18. The liquid crystal display device according to claim 17, wherein the gap between the TFT substrate and the counter substrate is determined by a spacer disposed in a pixel in which the conductive layer is formed to occupy the entire pixel.

19. The liquid crystal display device according to claim 1, wherein a plurality of the pixel electrodes are formed in a matrix pattern, and wherein each of a plurality of pixels disposed continuously in the scanning line extending direction has the counter electrode formed therein to occupy the entire pixel.

20. The liquid crystal display device according to claim 19, wherein the gap between the TFT substrate and the counter substrate is determined by a plurality of spacers disposed in a manner corresponding to a plurality of pixels arrayed in the scanning line extending direction, each of the pixels having the third electrode formed therein to occupy the entire pixel.
